(19) United States
(12) Patent Application Publication
(10) Pub. No.: US 2002/0003314 A1
(43) Pub. Date: Jan. 10, 2002

(54) AERATION DEVICE FOR WATER AND A METHOD FOR MANUFACTURING AN AERATION DEVICE

(76) Inventor: THOMAS CANTZ, STAFA (CH)

Correspondence Address: SHOEMAKER AND MATTARE LTD, SUITE 1203, CRYSTAL PLAZA BUILDING 1 P O BOX 2286, 2001 JEFFERSON DAVIS HIGHWAY, ARLINGTON, VA, 22202

(21) Appl. No.: 09/261,493

(22) Filed: Mar. 3, 1999

(30) Foreign Application Priority Data
Mar. 3, 1998 (EP) 98103729.4

(51) Int. Cl. F02M 1/00; C10J 1/08

(52) U.S. Cl. 261/124

(57) ABSTRACT

An aeration device for waste water (1) consists essentially of a carrier (2) with a flat, essentially rectangular surface (3) and of an air-permeable membrane (6) which is connected to the carrier (2). Between the membrane (6) and the carrier (2) there is formed an air chamber (7a, 7b). The rectangular, flat construction on the one hand permits a modular design of the aeration device (1) and further permits the manufacture of the aeration device with the coextrusion method.

### An Aeration Device For Water And A Method For Manufacturing An Aeration Device

The invention relates to an aeration device for water, in particular for waste water and to a method for manufacturing an aeration device.

For aerating waste water in treatment works a multitude of various aeration arrangements are known. For example tubular aerators are applied which are surrounded by a membrane through which small air bubbles may exit into the water to be aerated. Such tube aerators are often described as line aerators because the aerators may be arranged in a line in the clearing basin.

Alternatively also so-called aeration plates are known. Such plates consist generally of a round support plate, through which air is supplied, and of a porous membrane fastened to the edge of the support plate. Such plate aerators are placed individually onto an air supply conduit layed in the clearing basin.

Furthermore roughly rectangular plate aerators are known, which comprise a cushionlike membrane fastened in a frame, and which for example are fastened below a grid network on the floor of the clearing basin.

These various known aerator arrangements are all laden with disadvantages. Thus the manufacture of tube aerators is relatively complicated since a membrane must be assembled around the tubular base body. Furthermore with such tube aerators, on account of their arcuate surface there exists the problem of coalescence (unification of the exiting air bubbles).

Plate aerators are complicated in their manufacture and in particular in their assembly.

Furthermore aerators on account of the aging of the material must be exchanged from time to time. With plate aerators each individual plate must be disassembled and replaced. This leads to a complicated maintenance. Plate aerators are moreover complicated in manufacture and likewise are complicated in the maintenance.

It is therefore the object of the present invention to avoid the disadvantages of that which is known, in particular to provide an aeration device for water, in particular waste water, which is simply and economically manufacturable, which, without a large effort can be assembled and exchanged, and which ensures a good distribution of the air bubbles. A further object lies in providing an aeration device with individual, standardised construction modules.

A further object of the present invention lies in providing a simple method for manufacturing such an aeration device.

Apart from waste water aeration the invention may also be applied to the aeration of still water, such as natural ponds or breeding ponds.

The aeration device according to the present invention consists essentially of a carrier with a flat or arcuate, essentially rectangular-shaped surface with longitudinal and transverse sides. The ratio of the length to width of at least 3, preferably at least 15:1 permits the optimal, rational manufacture as extrusion parts.

The rectangular surface ensure a homogeneous exit of the small gas bubbles and also permits modular components with a variable length to be manufactured. Different from plate aerators, with an aeration device according to the present invention a freely selectable length in a clearing basin may be equipped with a single aeration device.

Advantageously the ratio of the length of the longitudinal and transverse sides is about 15 to 1 to 30 to 1. On the carrier, in particular on its surface, there is attached an air permeable membrane which preferably at least partly, along the longitudinal sides of the surface, is connected to the carrier. The membrane and carrier enclose at least one air chamber. An air supply arrangement for filling the air chamber with air is provided. As soon as air under pressure is introduced into the air chambers the membrane curves, the pores of the membrane open and the air may exit into the waste water to be aerated.

Such an aeration device may preferably be manufactured by coextrusion of a carrier and of a membrane. The carrier consists generally of a relatively rigid material and the membrane must have a sufficient strength and elasticity. By coextrusion with the same manufacturing method the carrier and the membrane may be manufactured and simultaneously permanently connected to one another.

Of course a coextrusion method may also be applied to aeration devices which comprise a carrier with a non-flat surface. The simplicity of the manufacturing method in this case also comes to fruition.

In a preferred embodiment example the membrane, along a middle line running essentially parallel to the longitudinal sides of the surface of the carrier, is connected to the surface of the carrier. In this manner the membrane and the carrier enclose two air chambers. The distribution of the small gas bubbles is improved since the curvature of the surface of the individual air chambers becomes smaller.

In a further preferred embodiment example the air chambers of the aeration device are connectable along at least one transverse side to the air supply means.

The connection to an air supply on the transverse side simplifies the construction of the carrier, since in contrast to plate aerators no air supply in the carrier itself is necessary. Thus a coextrusion method can be carried out particularly simply.

Advantageously furthermore the carrier is provided with fastening means for the releasable and positive and non-positive fitting connection of the aeration device in a retaining device. The releasable and positive and non-positive connection of the aeration device in the retaining device has advantageous effects in particular for the maintenance, i.e. for the exchange of the aeration devices. Thanks to the releasable connection, the aeration device may be simply lifted from the retaining device and removed from the clearing basin, without the clearing basin having to be emptied. Of course such a releasable connection is also advantageous with other types of aeration devices.

The fastening means are arranged on the lower side distant to the surface of the carrier.

The aeration device may further comprise cavities which may be filled out with a ballasting medium. The cavities between the carrier and membrane of the aeration device and in the air supply produce a thrust which normally requires a firm anchoring of the aeration device. On account of the cavities for receiving a ballasting material this thrust may be essentially compensated. The necessity of a stable anchoring is therefore done away with. Since no stable anchoring is required the releasability of the aeration device from the retaining device is particularly simple in accomplishing.

In a further embodiment example the cavities are mounted in the fastening means of the aeration device. The fastening means may in particular be formed as an essentially cylindrical tube which along a circumferential section may be snapped into a retaining device and which is formed for receiving a ballasting medium. An aeration device with a flat carrier and fastening means with an essentially round cross section may be extruded particularly simply.

In a further preferred embodiment example the aeration device is furthermore provided with means for draining the air chambers. It is possible that during operational interruptions water may enter into the air chambers. It is therefore advantageous when the draining means function automatically, i.e. possibly contained water is immediately ejected from the air chambers.

The carrier may be manufactured of polypropylene and the membrane from a thermoplastic elastomer. By way of coextrusion these two materials may be connected to one another and the mechanical properties different for the carrier and the membrane are ensured.

The aeration device is advantageously manufactured by coextrusion. With this a carrier and the membrane are commonly extruded in each case of an individual raw material and connected to one another by the extrusion.

In this manner particularly intimate connection is made possible in a single manufacturing method.

In an advantageous embodiment example of the method according to the invention the membrane subsequently is subjected to a method for increasing its air permeability, in particular to perforation.

The coextrusion method is of interest in particular with regard to modular components.

With a coextrusion method simple components with various lengths may be manufactured.

The advantage of modular components may however be achieved also very generally with aeration devices which consist of an extruded plastic hollow profile. The ratio of height to width should in this case be at least 1:3. It is the case here therefore of a relatively narrow aerator. The profile may consist of a single material which is perforated for producing a gaspermeable surface. In such a case at least one middle web in the cavity is for increasing the stability. It is however also conceivable to manufacture such a profile from two materials which have a differing mechanical strength (rigid lower part/flexible upper part).

The invention is hereinafter explained in more detail in embodiment examples and by way of the drawing.

There are shown:

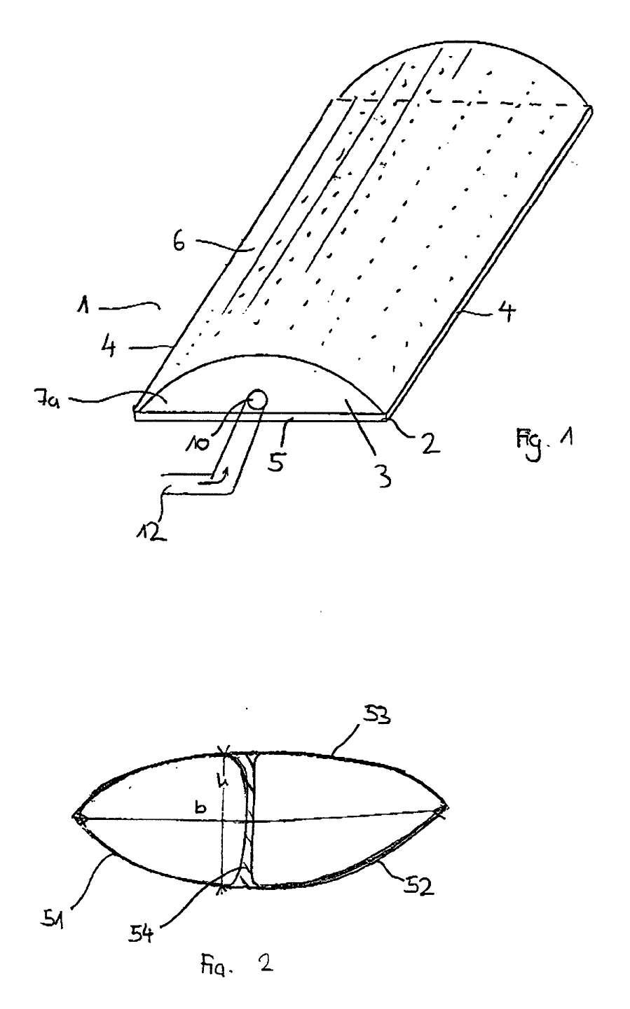

FIG. 1 a schematic perspective representation of an aeration device according to the invention,

FIG. 2 a schematic representation of an alternative embodiment example in cross section,

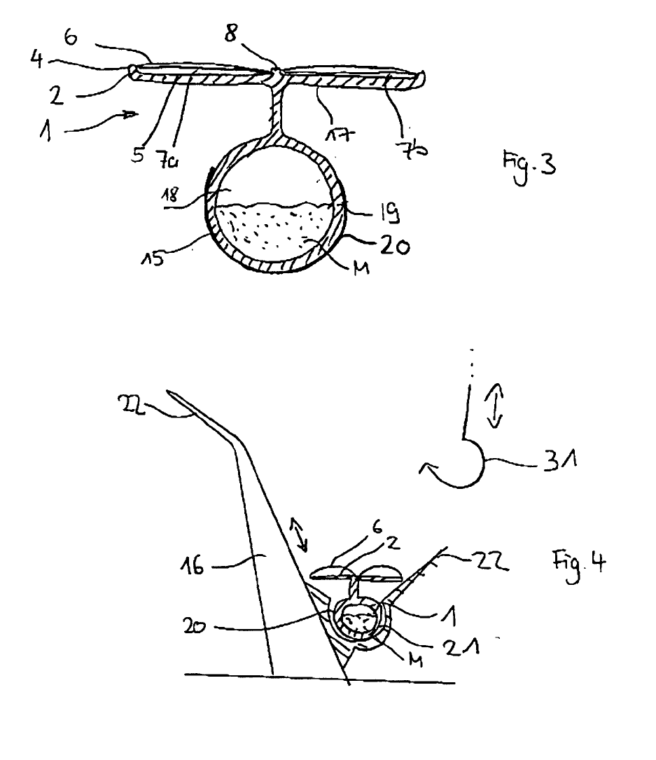

FIG. 3 a cross section through an aeration device according to the invention,

FIG. 4 a schematic representation of an aeration device according to the invention, in a retaining device,

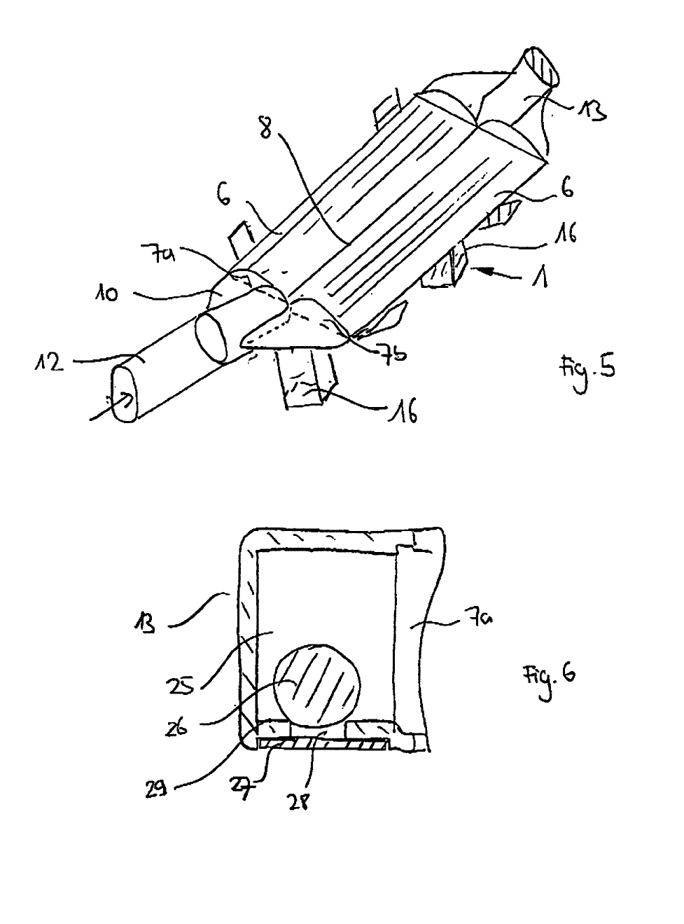

FIG. 5 a schematic representation of an aeration device according to the invention, with an air supply,

FIG. 6 a schematic representation of means for draining the air chambers.

In FIG. 1 there is schematically shown an aeration device 1 according to the invention. The aeration device 1 consists essentially of a carrier 2 with a flat surface 3 and with longitudinal sides 4 and transverse sides 5. Along the longitudinal sides 4 a membrane 6 is connected to the carrier. The membrane 6 and the carrier 2 enclose an air chamber 7a. The membrane 6 may likewise be connected directly to the carrier 2 along the transverse side 5 or special connection pieces may be used. On the one side the air chamber 7a is closed along the transverse side 5 and on the other side there is provided an air connection 10, which via a connection conduit 12 is connected to an air conduit. The membrane 6 is provided with perforations which permit the exit of small air bubbles into the waste water to be cleared.

In a clearing basin there are arranged several aeration devices 1. The aeration devices 1 are designed in a modular construction in modules of various lengths. This construction permits an individual equipping of the clearing basin with aeration devices 1. The aeration devices 1 are releasably held in each case on two retaining devices 16 with a positive and non-positive fit, which permits an easy assembly and removal of the aeration device 1. Each of the aeration devices 1 is connected to an air conduit via a flexible air supply tubing 12.

FIG. 2 shows an alternative embodiment example of an aeration device 51 in cross section. The aeration device 51 comprises an essentially gas-impermeable lower side 52 and a gas permeamble upper side 53 and is formed as a plastic hollow profile. A middle web 54 serves for increasing the stability. The ratio between height h and width b is about 1:3, but may however also be larger.

FIG. 3 shows the profile of an aeration device 1 according to the invention in cross section. The aeration device 1 consists of an essentially T-shaped carrier 2 and of a membrane 6 attached on the upper side 4 of the carrier 2. On the lower side 17 of the carrier there are arranged fastening means 15 which are designed in the form of a tube 19. The membrane 6 along the longitudinal sides 4 is connected to the carrier 2. Between the membrane 6 and the carrier 2 there are enclosed two air chambers 7a and 7b. The membrane 6 is formed in two parts and along a middle line 8 which runs parallel to the longitudinal sides 4 is connected to the carrier 2. The formation of two air chambers 7a, 7b leads to a symmetric design and avoids coalescence (unification of bubbles).

The fastening means 15 are provided with a cavity 18 which serves for accommodating a ballasting medium M. The ballasting medium M serves for compensating the thrust of the air chambers 7a, 7b between the carrier 2 and the membrane 6 in water.

FIG. 4 shows schematically a retaining device 16 in which an aeration device 1 according to the invention is retained. The retaining device is designed adjustable in height which permits a simple levelling of the aeration device. The aeration device along a circumferential section 20 of the tube 19 (see FIG. 3) is snapped into a receiver opening 21 of the retaining device 16. Introduction aids 22 are provided, these simplifying the insertion of the aeration device 1 into retaining device 16. Schematically in FIG. 4 there is represented a lifting device 31 by way of which the fastening device is gripped from below, snapped out of the retaining device 16 and lifted from the clearing basin.

FIG. 5 shows schematically an aeration device 1 according to the invention which is assembled on two retaining devices 16. The aeration device 1 comprises two air chambers 7a and 7b. The air chambers are on the one side closed by an end piece 13 and on the other side by an air connection 10 and via a flexible connection conduit 12 connected to an air supply. Thanks to this design the aeration device 1 may be manufactured as an extrusion profile in any length. The air supply is effected on the end face of the aeration device 1.

In FIG. 6 there is provided a device for draining the air chambers 7a and 7b. In the end piece 13 a downwardly aligned opening may be provided which is closed with a tension rubber 27. A ball 26 which is lighter than water is placed from the inner side of the end piece 13 into the opening 28. As soon as water exits from the air chambers 7a into the end piece 13 and the air supply is interrupted, the ball is lifted, and the water may exit downwards through the opening 28. As soon as the air supply is again turned on, the water is pressed out through the opening.

As soon as there is no longer any water present in the draining means 25, the ball 26 sinks again onto the opening 28 and the opening 28 is closed. The floor 29 of the draining means 25 is advantageously arranged deeper than the surface 3 of the carrier 2, so that any occuring water entering into the air chambers 7a automatically flows into the draining means 25.

The carrier 2 is preferably manufactured from polypropylene. The membrane may be manufactured from a thermoplastic elastomer such as for example Santoprene. The individual modules of the aeration device 1 comprise typically a length of 1 to 8 meters. The thickness of the membrane 6 is between 1 and 3 mm, the thickness of the carrier 2 approx. 4 to 6 mm. The air chambers are in each case approx 50 to 150 mm wide, which leads to a total width with two air chambers 7a, 7b of 10 to 300 mm. As a ballasting medium M preferably sand is used. However other materials such as gravel, stone, concrete, etc. are conceivable.

1. An aeration device (1) for water, in particular waste water, characterised by a carrier (2), with an essentially rectangular surface, with longitudinal and transverse sides (4,5), wherein the longitudinal side (4) is at least 3 times, preferably at least 15 times larger than the transverse side (5), and by at least one air-permeable membrane (6) which preferably along the longitudinal side (4) of the surface (3) is connected to the carrier (2), wherein the membrane (6) and the carrier (2) enclose at least one air chamber (7a, 7b), wherein the carrier (2) and the membrane (6) are preferably formed symmetrically and wherein the plane of symmetry halves the membrane surface.

2. An aeration device (1) preferably according to claim 1 with a carrier (2) and with an air-permeable membrane fastened on the surface of the carrier, wherein the membrane (6) and the carrier (2) enclose at least one air chamber (7a, 7b), characterised in that the carrier and the membrane are extruded, preferably coextruded.

3. An aeration device according to one of the claims 1 or 2, characterised in that the membrane along a middle line (8) running essentially parallel to the longitudinal sides (4) of the surface (3) is connected to the surface (3) of the carrier (2) in such a manner that the membrane (6) and the carrier (2) enclose two air chambers (7a, 7b).

4. Aeration devices according to one of the claims 1 to 3, characterised in that the aeration device (1) along at least one transverse side (5) is connectable to an air supply means(10, 11,12).

5. An aeration device in particular according to one of the claims 1 to 4, characterised in that the carrier (2) is provided with fastening means (15) for the releasable and positive fitting and non-positive fitting connection of the the aeration devices (1) in a retaining device (16).

6. An aeration device according to claim 5, characterised in that the fastening means (15) are arranged on the lower side (17) of the carrier (2), which is distant to the surface (3).

7. An aeration device according to one of the claims 1 to 6, characterised in that the aeration device (1) comprises cavities (18) which can be filled up with a ballasting medium (M).

8. An aeration device according to one of the claims 5 or 6 and claim 7, characterised in that the cavities (18) are arranged in the fastening means (15).

9. An aeration device according to one of the claims 4 to 7, characterised in that the fastening means (15) are formed as an essentially cylindrical tube (19), which along a circumferential section (20) can be snapped into a retaining device and which is formed for accommodating a ballasting medium.

10. An aeration device according to one of the claims 1 to 9, characterised in that the aeration device (1) is provided with means (15) for draining the air chambers (7a, 7b).

11. An aeration device according to one of the claims 1 to 10, characterised in that the carrier (2) consists of polypropylene and the membrane (6) of a thermoplastic elastomer.

12. A method for manufacturing an aeration device (1), in particular according to one of the claims 1 to 11, with a carrier (2) and with a membrane fastened on the surfaces (3) of the carrier (2), in particular according to one of the claims 1 to 11, characterised in that the membrane (6) and the carrier (2) are simultaneously manufactured and connected to one another with the coextrusion method.

13. A method for manufacturing an aeration device according to claim 12, characterised in that the membrane (6) is subsequently subjected to a method for increasing its air permeability, in particular to perforation.

14. An aeration device (51) for water, in particular waste water, characterised in that the aeration device consists essentially of a section of extruded plastic hollow profile which comprises a gas-permeable upper side (53) and an esentially gas-impermeable lower side (52), wherein the hollow profile has a ratio of height (h) to width (b) of the inner space of at the most 1:3.

15. An aeration device (1) according to claim 14, characterised in that the hollow profile comprises strengthening means, in particular a middle web.
